(19) United States
(12) Patent Application Publication
(10) Pub. No.: US 2015/0222228 A1
(43) Pub. Date: Aug. 6, 2015

(54) METHOD FOR CHARACTERIZING A PHOTOVOLTAIC ELEMENT, DEVICE FOR CHARACTERIZING THE PHOTOVOLTAIC ELEMENT, ASSOCIATED PROGRAM AND STORAGE MEDIUM

(71) Applicant: COMMISSARIAT A L'ENERGIE ATOMIQUE ET AUX ENERGIES ALTERNATIVES, Paris (FR)

(72) Inventors: Henri Zara, Charnay (FR); Jens Merten, Tresserve (FR)

(73) Assignee: COMMISSARIAT A L'ENERGIE ATOMIQUE ET AUX ENERGIES ALTERNATIVES, Paris (FR)

(21) Appl. No.: 14/429,124

(22) PCT Filed: Sep. 13, 2013
(86) PCT No.: PCT/EP2013/068974

§ 371 Date: Mar. 18, 2015

(30) Foreign Application Priority Data
Sep. 24, 2012 (FR) 12 58921

(51) Int. Cl. H02S 50/10

(52) U.S. Cl. CPC H02S 50/10

(57) ABSTRACT

The method for characterizing a photovoltaic element (4) comprises a phase of studying (E1) a behaviour of the photovoltaic element (4) in response to the application of a light beam from a light source (2), for example a matrix of light-emitting diodes, at a study emitting power. Said study phase (E1) comprises a step of measuring (E1-1) at least one electrical parameter (I, V) representative of the operation of the photovoltaic element (4). Furthermore, the method comprises an initialisation phase (E2), performed before the study phase (E1), comprising a step of adjustment (E2-1) of an operating temperature of the light source (2) as a function of the study emitting power.

### TECHNICAL FIELD OF THE INVENTION

The invention relates to the field of photovoltaic energy. The subject of the invention is more particularly a method for characterizing a photovoltaic element allowing for the study thereof.

### STATE OF THE ART

A photovoltaic panel can be characterized under a variable lighting (VIM, standing for “Variable Illumination Method”). The VIM analysis proposed makes it possible to define the parameters of the electrical model of the photovoltaic panel. This analysis requires a large number of “current/voltage” measurements over a wide lighting dynamic range.

Usually, the photovoltaic panels are characterized under natural lighting outdoors over several days, even several months. These measurement campaigns are therefore lengthy but necessary to obtain a large number of operating points over a range of sunlight and temperature.

There are light-emitting diode lighting banks which make it possible to “flash” the panels during production, but such equipment does not make it possible to perform a VIM analysis.

The documents US2010/0073011, JP2011009358 and CN101290340 describe particular implementations of test lighting banks.

The document by Bliss M et al entitled “Performance measurements at varying irradiance spectrum, intensity and module temperature of amorphous silicon solar cells” from the conference “35th IEE Photovoltaic specialists conference (PVSC)” dated 20-25 Jun. 2010 held in Honolulu, Hi., USA describes, on pages 2660-2665, a test bench in which the temperature of the photovoltaic device to be tested is adjusted.

The document by A. Lo et al entitled “An Hybrid LED/Halogen large area solar simulator allowing for variable spectrum and variable illumination pulse shape ” from the conference “25th European Photovoltaic Solar Energy Conference and Exhibition/5th World Conference on Photovoltaic Energy Conversion” dated 6-10 Sep. 2010 held in Valence in Spain describes a solar simulator based on light-emitting diodes or halogen lighting in the form of a matrix.

There is therefore an issue concerning the tests of the photovoltaic panels, notably on lighting banks that make it possible to perform tests correctly and rapidly.

### OBJECT OF THE INVENTION

The aim of the present invention is to propose a solution which remedies the drawbacks listed above.

This aim is targeted by the use of a method for characterizing a photovoltaic element comprising a phase of studying a behaviour of the photovoltaic element in response to the application of a light beam from a light source, for example a matrix of light-emitting diodes, at a study emitting power, said study phase comprising a step of measuring at least one electrical parameter representative of the operation of the photovoltaic element, said method further comprising an initialisation phase, performed before the study phase, comprising a step of adjustment of an operating temperature of the light source as a function of the study emitting power.

According to one implementation, the step of adjustment comprises a step in which the light source is passed through by an electrical current that is a function of the study emitting power, said study phase being triggered when said operating temperature is stabilised.

According to another implementation, the step of adjustment comprises a step in which the light source is passed through for an initialisation time by an electrical current of an intensity that is a function of an initialisation emitting power different from the study emitting power.

Advantageously, the initialisation time is a function of a value representative of a current temperature of the light source prior to the triggering of the initialisation phase, and of a value representative of a desired temperature of the light source associated with the study emitting power of the study phase.

For example, the current temperature T0 being lower than the desired temperature T1, the initialisation time t is calculated according to the formula (Tmax−T0)*(1−e^{-t}^{_{/Rth.Cth}})=T1−T0 with Tmax being the temperature associated with the initialisation emitting power, Rth the thermal resistance of the thermal model of the light source, Cth the heat capacity of the thermal model of the light source.

According to another example, the current temperature T0 being higher than the desired temperature T1, the initialisation time t is calculated according to the formula T0.e^{-t}^{_{/Rth.Cth=T}}1 with Rth being the thermal resistance of the thermal model of the light source, Cth the heat capacity of the thermal model of the light source, and, during the adjustment step, the initialisation emitting power of the light source is zero.

Preferably, the method comprises at least two successive study phases associated with different study emitting powers, each study phase being preceded by an associated initialisation phase.

According to a refinement, the study phase comprises a step of homogenization of the lighting received by at least a part of the photovoltaic element. The step of homogenization of the lighting can be implemented by means of a reflection element and/or of a control of the operation of light-emitting diodes of the light source.

Advantageously, the electrical parameter measured during the measurement step is the voltage and/or the current from the photovoltaic element.

The invention also relates to a device for characterizing a photovoltaic element comprising: a light source; an element for studying the behaviour of the photovoltaic element in response to the application of a light beam from the light source and exhibiting a study emitting power, said study element being provided with at least one system for measuring an electrical parameter from the photovoltaic element; and an initialisation component configured to adjust an operating temperature of the light source as a function of the study emitting power.

The device can comprise a computation unit interfaced with the initialisation component and the study element, said computation unit being configured to perform the method as described.

According to a refinement, the device comprises a reflection element comprising a duct provided with two ends, the light source being arranged at one of the ends of the duct such that the light beam is directed in the duct towards the other end of the duct comprising a bearing surface suitable for being placed in contact on an active face of the photovoltaic element, an internal surface of the duct being at least partially formed by a mirror. The interior of the duct can be delimited by a cylinder notably of square or rectangular section.

Moreover, the light source can comprise a matrix of light-emitting diodes.

Advantageously, the light-emitting diodes of the matrix of diodes being arranged in the form of a square or a rectangle, the distance separating the two ends of the duct is substantially equal to the distance from the greater side of the matrix of diodes.

Furthermore, the matrix of diodes can be divided into a plurality of groups each comprising at least one diode, the emitting powers of the groups being controlled independently from one group to another.

The invention also relates to a computer-readable data storage medium, on which is stored a computer program comprising computer program code means for implementing phases and/or steps of a method as described.

The invention also relates to a computer program comprising a computer program code means suitable for carrying out phases and/or steps of a method as described, when the program is executed by a computer.

### BRIEF DESCRIPTION OF THE DRAWINGS

Other advantages and features will emerge more clearly from the following description of particular embodiments of the invention given as nonlimiting examples and represented in the attached drawings, in which:

FIG. 1 represents a diagram of a method for characterizing a photovoltaic element,

FIG. 2 illustrates an equivalent electrical model of the thermal behaviour of a light source as used for example in the method,

FIG. 3 illustrates two graphs respectively representative of the trend of the temperature and of the current passing through the light source in time for one and the same characterization period, these two graphs being representative of what happens without the implementation of the method of FIG. 1,

FIGS. 4 and 5 each illustrate two graphs respectively representative of the trend of the temperature of the light source and of the intensity of the current passing through the light source in time for one and the same characterization period, these two graphs being representative of what happens with the implementation of the method of FIG. 1,

FIG. 6 schematically illustrates an implementation of a characterization device,

FIG. 7 illustrates an embodiment of the characterization device,

FIG. 8 illustrates a view according to the cutting plane A of

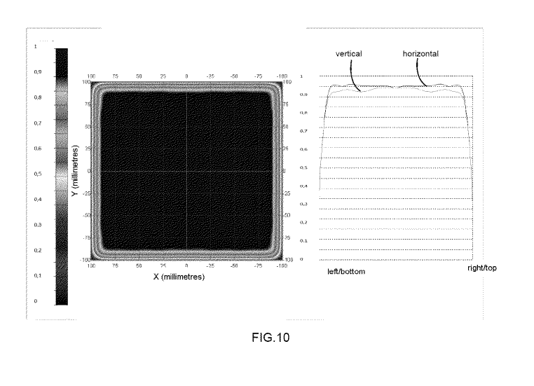

FIG. 7,

FIG. 9 illustrates the distribution of the light irradiation on the surface of a photovoltaic element without the implementation of the refinement of FIG. 7,

FIG. 10 illustrates the distribution of the light irradiation on the surface of a photovoltaic element with the implementation of the refinement of FIG. 7.

### DESCRIPTION OF PREFERENTIAL EMBODIMENTS OF THE INVENTION

The method and the device described hereinbelow differ from the prior art notably in that a study phase is performed so as to dispense with the heat variations of the light source. This can be implemented by providing an initialisation step that makes it possible to adjust the operating temperature of the light source as a function of a study emitting power of said light source provided during the study phase.

In the present description, the power can be measured in W/m².

In fact, to perform a test, the light source can be passed through by an electrical current of fixed intensity. This electrical current will be associated with a reference temperature and a reference emitting power. At fixed current, the temperature and the emitting power can vary to converge towards stabilised values after a certain time, the emitting power being a function of the temperature and of the current. In order to best characterize a photovoltaic panel, it is preferable to carry out the study thereof when the temperature is stabilised. In fact, when the temperature is stabilised, the emitting power is also stabilised, and vice versa.

In the context of a light source based on light-emitting diodes, the intensity of the light beam is practically proportional to the intensity of the electrical current passing through the light source when the temperature is stabilised. It is therefore possible to take as reference the intensity of the current passing through the diodes as an image of the lighting produced, when the stabilisation is reached. In other words, it is possible to have a table giving, for different current values, stabilised temperature and emitting power values.

In the present description, the term “photovoltaic element” should be understood to mean either a photovoltaic panel as a whole comprising a plurality of individual photovoltaic cells, or a single individual photovoltaic cell, or a number of individual photovoltaic cells for example partially constituting a photovoltaic panel.

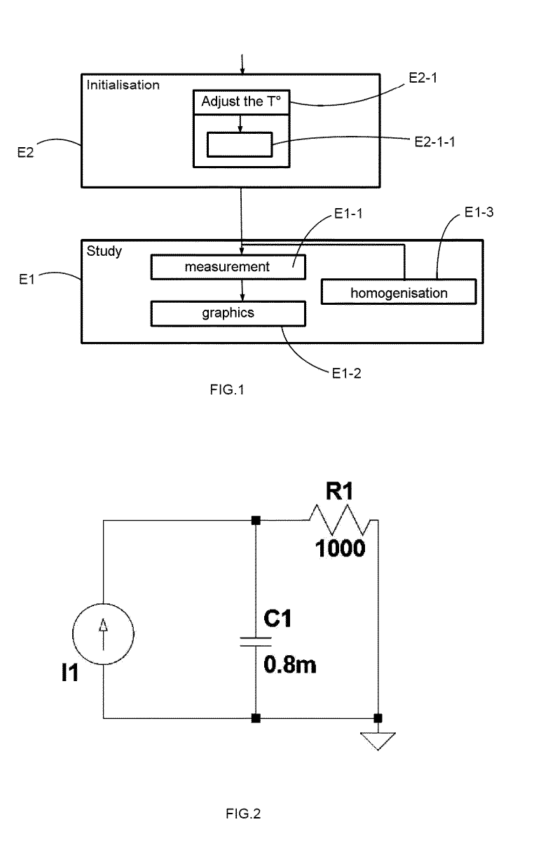

As illustrated in FIG. 1, the method for characterizing a photovoltaic element comprises a phase of studying E1 a behaviour of the photovoltaic element in response to the application of a light beam from a light source (for example a matrix of light-emitting diodes) at a study emitting power. This study phase E1 comprises a step E1-1 of measuring at least one electrical parameter representative of the operation of the photovoltaic element. This electrical parameter measured during the measurement step can be the voltage and/or the current from the photovoltaic element. Following the measurement step, graphs (or reference tables) of the quantity or quantities measured can be produced in a step E1-2, these graphs making it possible to interpret the operation of the photovoltaic element.

Advantageously, for a given study phase at an associated study power, the parameter or parameters measured (voltage and/or current), are measured at regular intervals so as to determine the behaviour of the photovoltaic element throughout said study phase.

Furthermore, the method comprises an initialisation phase E2, performed before the study phase E1. This initialisation phase E2 comprises a step of adjusting E2-1 an operating temperature of the light source as a function of the study emitting power.

The light source is configured so as to reproduce natural lighting conditions by using an artificial lighting, notably produced by light-emitting diodes, in particular of power type. The advantage provided by the power light-emitting diodes lies in the possibilities for driving the duly formed light source in terms of dynamic range of the emitting power (greater than 10^{E}6W/m²) and of the accurate control of the lighting time.

The use of the initialisation phase E2 is to limit the operating variations of the light source due to a drift of the operating temperature during the study phase.

In fact, a light source formed by a matrix of light-emitting diodes mounted on a dissipater can be modelled according to a particular thermal model, an electrical equivalent model of which is illustrated in FIG. 2 in which I1 is the current passing through the model, R1 is the electrical resistance of the model (1000 Ω in the example), C1 representing the capacity of the model (0.8 m in the example) and V the voltage associated with said model. In this example, the matrix of diodes as a whole can be considered as a single heat source attached to a dissipater. Obviously, a discretisation of each diode would refine the model, but will not be described here. For its part, the thermal model gives a power P in watts, a thermal resistance Rth in K/W, a heat capacity Cth in J/K, and a temperature T. In fact, the thermal resistance considered Rth can link a corresponding hotpoint to the electronic junction of the diodes at room temperature, and it represents the resistance equivalent to the different thermal resistances which exist between the different junctions.

More specifically, the thermal resistance Rth of the thermal model of the light source can correspond to the thermal resistance between the junction of the diodes of the matrix of diodes and the ambient air, and the heat capacity Cth of the thermal model of the light source can correspond to the calorific capacity of the matrix of diodes.

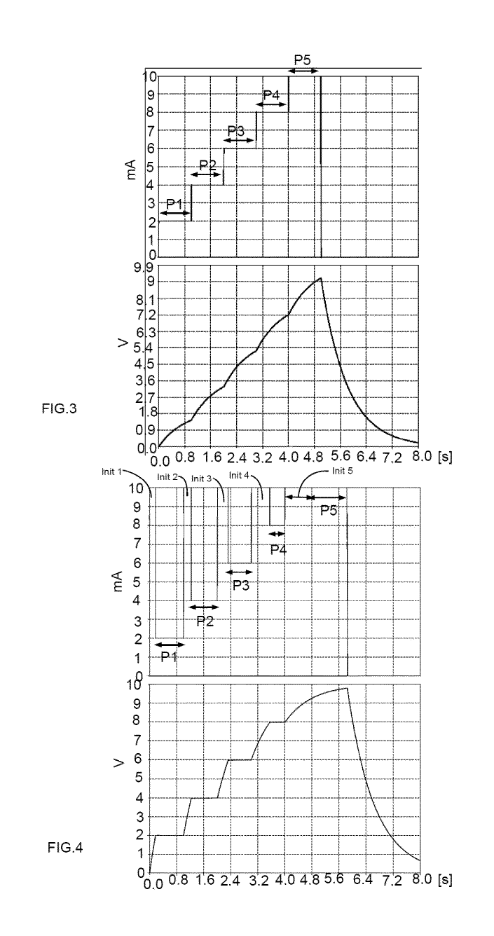

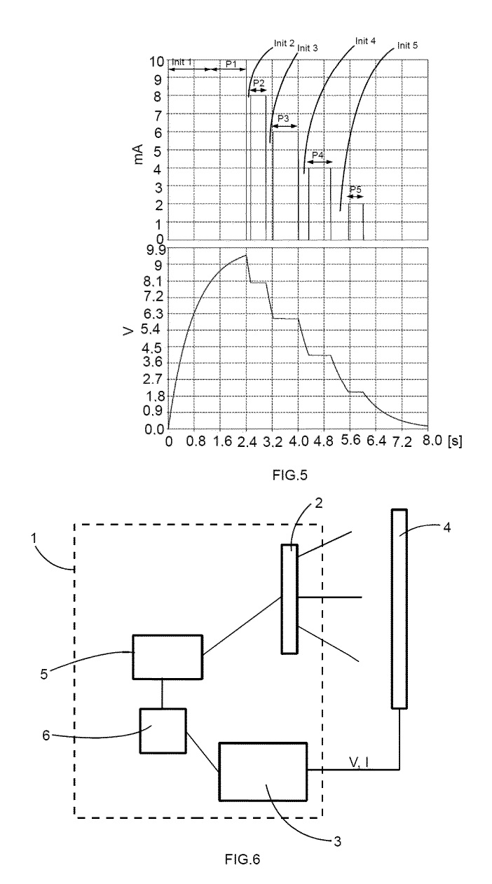

FIG. 3 associates a graph representative of the trend of the current passing through the light source (current I1 of the model) as a function of time for different successive study phases P1 to P5, with a graph of the trend of the temperature (voltage V1 of the model) as a function of time.

The study phases P1 to P5 are each associated with a different study emitting power, increasing from one phase to the next in time. It can be seen clearly in FIG. 3 that the different study phases P1 to P5 are performed directly one after the other, and that upon the transition from one study phase to another, the temperature is not yet stabilised, which induces errors in the characterization of the associated photovoltaic panel.

The method implemented in the context of the present invention will seek to limit these characterisation errors.

According to a first embodiment, the adjustment step E2-1 comprises a step in which the light source is passed through by an electrical current that is a function of the desired study emitting power. Thus, when the adjustment step E2 is triggered, the light source is passed through by the electrical current associated with the study emitting power and the study phase E1 is triggered when said operating temperature is stabilised.

According to a particular implementation of the first embodiment, the operating temperature is considered as stabilised when at least one of the following parameters is verified:
the operating temperature remains constant, or varies within a range of plus or minus 1° C., during a predetermined period, for example a predetermined period of 5 seconds,
a predetermined time period, for example 10 minutes to 30 minutes, has elapsed since the light source was switched on.

The result of the above is that it is possible to wait for the temperature of the light source to stabilise to consider that the study phase can be triggered.

From this first embodiment, there results an issue of optimising the time to implement such a method. In effect, the waiting time between different study phases is fairly significant, and efforts will be made consequently to reduce it.

Thus, the second embodiment described hereinbelow makes it possible to reduce the waiting time notably between two study phases of the method, or in one study phase in particular.

According to this second embodiment, the adjustment step E2-1 comprises a step E2-1-1 in which the light source is passed through for an initialisation time by an electrical current of intensity that is a function of an initialisation emitting power different from the study emitting power subsequently desired. Thus, upon the triggering of the adjustment step E2-1, the emitting power varies so as to tend towards the initialisation emitting power. In other words, during this adjustment step, an electrical current of intensity greater than or less than that of the electrical current which will be used in the study phase is momentarily (for an initialisation time) ordered so as to make the temperature of the LEDs increase or decrease more rapidly.

In fact, it will be understood that, preferably, the temperature of the light source is adjusted before the study phase in particular by a control of the electrical current exhibiting an intensity that is a function of the study emitting power.

The initialisation time makes it possible, among other things, to obtain a constant temperature of the light source during a study phase. Preferably, in order to ensure that the desired temperature is obtained, it can be measured as close as possible to the light source, for example at different points of the matrix of diodes to check the uniformity thereof.

In fact, the initialisation time can advantageously be a function (that is to say for example calculated from) a value representative of a current temperature of the light source prior to the triggering of the initialisation phase E2, and of a value representative of a desired temperature (the temperature representative of the stabilised temperature for a given study phase) of the light source associated with the study emitting power of the study phase E1.

In a first case, if the current temperature T0 is lower than the desired temperature T1, the initialisation time t is calculated according to the formula (Tmax−T0)*(1−e^{-t}^{_{/Rth.Cth}})=T1−T0 (1) with Tmax being the temperature associated with the initialisation emitting power, Rth the thermal resistance of the thermal model of the light source, Cth the thermal capacity (also called calorific capacity) of the thermal model of the light source. In this example, the initialisation emitting power for example takes the maximum value of the emitting power possible for the light source.

In a second case, if the current temperature T0 is higher than the desired temperature T1, the initialisation time t is calculated according to the formula T0.e^{-t}^{_{/Rth.Cth=T}}1 (2) with Rth being the thermal resistance of the thermal model of the light source, Cth the thermal capacity of the thermal model of the light source, and, during the adjustment step E2-1, the initialisation emitting power of the light source is zero. “Zero” should be understood for example to mean that the light source is off.

From equations (1) and (2), a person skilled in the art will be able easily to extract the value of t to determine the optimum initialisation time.

The method can comprise at least two successive study phases E1 associated with different study emitting powers, each study phase E1 being preceded by an associated initialisation phase E2.

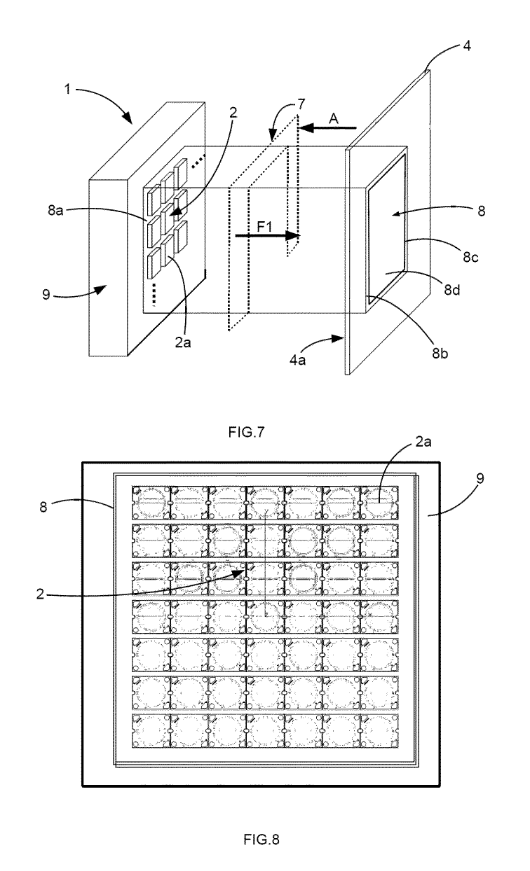

In fact, each study phase can be associated with an electrical current level passing through the light source that is representative of the desired study emitting power. FIGS. 4 and 5 are each associated with two graphs respectively giving the trend of the intensity of the current passing through the light source as a function of time, and a curve of trend of the temperature (the voltage in FIGS. 3, 4 and 5 represents the voltage V1 of the model, that is to say an image of the temperature of the light source) of the light source as a function of time. FIG. 4 comprises five test levels P1 to P5. Each of the five test levels P1 to P5 is associated with an initialisation phase preceding it, the initialisation phases being represented from Init1 to Init5. When the graph of the trend of the intensity of the current is correlated with that of the trend of the temperature, it can be seen that, during an initialisation phase, the temperature increases rapidly to pass from one level to the other. For FIG. 4, the time between each level representative of a study phase is determined by using equation (1) because the levels are rising (current intensity levels increasing in the example), in this case the current associated with the initialisation emitting power is equal to 10 mA.

FIG. 5 illustrates the same principle with descending levels P1 to P5 (current intensity levels decreasing in the example), equation (2) is applied to determine the durations of the initialisation phases Init2 to Init5. If the light source is off at the start, the first study phase P1 is associated with an initialisation phase Init1 of a duration corresponding to the time needed to achieve the stabilisation of the temperature of said light source (typically between 30 s and 5 min). During the initialisation phases Init2 to Init5 respectively associated with the times calculated according to equation (2), the intensity of the current passing through the light source is advantageously zero, or low relative to the current associated with the corresponding study emitting power.

Advantageously, the study phase E1 comprises a step of homogenization E1-3 of the lighting received by at least a part of the photovoltaic element. This homogenization step makes it possible to check that the lighting from the light source is as close as possible to natural lighting, that is to say uniform on the surface of an active face of the photovoltaic element.

“Active face” should be understood to mean the face of a photovoltaic element intended to be oriented towards the sun to receive photons. This step of homogenization E1-3 of the lighting can be implemented by means of a reflection element and/or a control of the operation of light-emitting diodes of the light source. In the control case, the light source is preferably a matrix of light-emitting diodes divided into a plurality of groups each comprising at least one diode, the lighting intensities of the groups being controlled independently from one group to another. The control can be produced from an electronic presetting of the diodes of the matrix of diodes.

The method as described above can be implemented by a characterization device specific to a photovoltaic element.

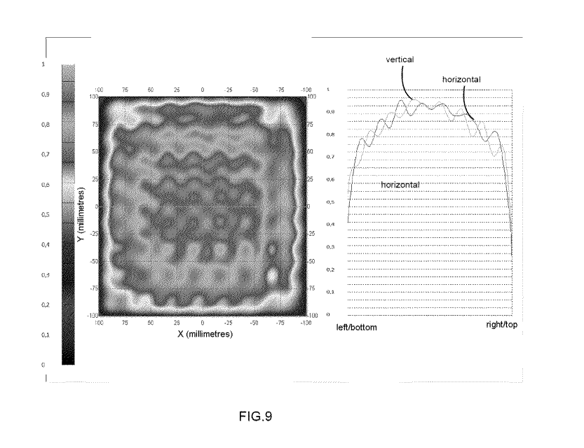

As illustrated in FIG. 6, such a characterization device 1 can comprise a light source 2, an element for studying 3 the behaviour of the photovoltaic element 4 in response to the application of a light beam from the light source 2 and exhibiting a study emitting power. Said study element 3 is provided with at least one system for measuring an electrical parameter I, V from the photovoltaic element 4. The device further comprises an initialisation component 5 configured to adjust an operating temperature of the light source 2 as a function of the study emitting power.

A computation unit 6 of the device 1 can be interfaced with the initialisation component 5 and the study element 3, said computation unit 6 being configured to perform the method as described above.

As illustrated in FIG. 7, the device 1 can, according to one implementation, comprise a reflection element 7 comprising a duct 8 provided with two ends 8a, 8b. The light source 2 is arranged at one of the ends 8a of the duct 8 such that the light beam is directed (arrow F1) in the duct 8 towards the other end 8b of the duct 8. Said other end 8b comprises a bearing surface 8c suitable for being placed in contact on an active face 4a of the photovoltaic element 4. An internal surface 8d of the duct 8 is at least partially formed by a mirror. Advantageously, the entire internal surface of the duct 8 forms a mirror, or is formed by an arrangement of a plurality of mirrors. In other words, the entire internal surface 8d of the duct 8 can reflect the light waves emitted by the light source 2. The mirror makes it possible to homogenize the lighting on the photovoltaic element 4, thus partially or totally performing the homogenization step of the method.

According to a particular implementation, in FIG. 7, the interior of the duct 8 is delimited by a cylinder notably of square or rectangular section. FIG. 8 represents a view along a cutting plane represented by broken lines in FIG. 7, substantially at right angles to the longitudinal axis of the duct 8 and oriented according to A. In this particular case, the light source 2 comprises a plurality of spots 2a suitable for emitting light, and the duct 8 surrounds the plurality of light spots at the level of a support element 9 bearing said light spots.

FIGS. 9 and 10 make it possible to illustrate the advantage of the use of reflection. These two FIGS. 9 and 10 highlight the role of the mirrors which have the effect of homogenizing the lighting over the entire field, even if the predominant effect lies at the edges. Simulations have been carried out in the following conditions: a lighting surface of 20×20 cm with a duct allowing a distance of approximately 20 cm between the plane of a matrix of light-emitting diodes and the study plane including the active face of the photovoltaic element. In FIGS. 9 and 10, there are, from left to right in the associated figure, a scale representative of the light power to standardized scale, a mapping of the power actually achieved in a study plane coinciding with the end 8b of the duct 8 opposite the light source 2 formed by the matrix of diodes, and a graph representing the lighting profiles of the mapping on a vertical axis and a horizontal axis both passing through the centre of the mapping. FIG. 9 corresponds to the use of a characterization device without reflection element, and FIG. 10 corresponds to the use of a characterization device equipped with a reflection element. It can be seen very clearly that the light power is distributed more uniformly in FIG. 10 than in FIG. 9. The result thereof is therefore that it is very advantageous to use the reflection element 7.

Advantageously, as described previously, the light source 2 comprises a matrix of light-emitting diodes 2a (FIGS. 7 and 8), for example of power type, preferably white, and advantageously arranged according to a controlled spacing. “Controlled spacing” should be understood to mean that the light-emitting diodes can be distributed uniformly on a lighting surface produced by the matrix of diodes. The light-emitting diodes 2a of the matrix of diodes 2 can be arranged in the form of a square or a rectangle, such that the distance separating the two ends 8a, 8b of the duct 8 is substantially equal to the distance from the greater side of the matrix of diodes.

According to one implementation, the matrix of diodes 2a is divided into a plurality of groups each comprising at least one diode 2a, the emitting powers of the groups being controlled independently from one group to another. In other words, the characterization device can comprise an electronic adjustment component making it possible to adjust the intensity of the lighting of the light-emitting diodes by controlling the current passing through the latter, independently or according to a group distribution. For the purposes of the characterization method, the light-emitting diodes are advantageously passed through by a continuous and non-pulsed current. In effect, the control of the light intensity that is generally done by controlling the duty cycle of the current is not applicable for the characterization of the photovoltaic cells, the response time of the photovoltaic cells being of the same order of magnitude as that of the light-emitting diodes. Each light-emitting diode, or group of light-emitting diodes, can be controlled separately so as to correct the defects of uniformity of the lighting. The component for adjusting the light-emitting diodes and the light-emitting diodes themselves make it possible to obtain a lighting dynamic range greater than 5 orders of magnitude. This feature is very advantageous in the case of a characterization of a photovoltaic panel, notably by the VIM method.

Generally, the light-emitting diodes of the matrix of diodes are mounted on a heat dissipater to best discharge the calories and thus avoid the overheating of the matrix of diodes.

The spectrum of the light-emitting diodes is advantageously close to the solar spectrum (white light) but nevertheless exhibits differences that are not prejudicial to the characterization method.

The wide lighting dynamic range offered by the light-emitting diodes, advantageously without spectrum variation, greater than 5 orders of magnitude, allows for a fine determination of the parameters of the model of the photovoltaic element.

Advantageously, as described previously, each of the light-emitting diodes, or each of the groups of light-emitting diodes, of the matrix is controlled individually by an electronic circuit which controls the current in the diode or the group of diodes. The matrix therefore has a unique control of the lighting but the emitting power of each light-emitting diode, or group of light-emitting diodes, can vary to obtain a uniform lighting. According to one implementation, the matrix of light-emitting diodes is controlled in lighting intensity by a system for controlling the lighting of the characterization device. The photovoltaic element is illuminated while the study element records the data to produce curves of voltage and intensity IV from the photovoltaic element. A supervision device makes it possible to parameterize and synchronize the lighting with the acquisition of the data intended to generate the IV curves. Then, a data processing unit makes it possible to extract IV curves of the parameters of the model.

The procedure for measuring the current and the voltage of the photovoltaic element performed during the step E1-1 of FIG. 1 can comprise the following successive steps:
measuring the extreme current and voltage values, that is to say the short-circuit current and the open-circuit voltage,
defining the best measurement rating of the current and voltage measurement instrumentation as a function of the measurements of the measurement step,
recording the current and voltage curve with synchronization of the current and voltage measurements. The measurement rating from the preceding step being kept identical during this recording step.

As explained above, the parameters measured during the study phase can be the voltage and/or the current from the photovoltaic element. Consequently, for each study phase, the study element can establish curves of trend of the current and/or of the voltage measured under the effect of the light beam. For this, the study element can comprise an apparatus making it possible to supply the photovoltaic element, notably a photovoltaic cell, over all four quadrants, that is to say with positive and negative current, and with positive and negative voltage (generator and load) while performing the simultaneous acquisition of the current and of the voltage.

A computer-readable data storage medium, on which is stored a computer program can comprise computer program code means for implementing the phases and/or steps of the method as described.

A computer program can comprise a computer program code means suitable for performing the phases and/or steps of the method as described, when the program is executed by a computer.

By virtue of the method as described, it is possible to obtain a very significant statistical sampling over a fairly short time band. Also, the measurements can be redone, even with low lighting, in a very reproducible way, this making it possible to produce a better definition of the model of the photovoltaic element.

Thus, it is possible to perform, under artificial lighting, a VIM analysis in a few minutes compared to the few weeks or months of the prior art under natural lighting. Consequently, the analysis obtained from the characterization method can be directly exploited on photovoltaic element production lines to improve the production thereof.

In fact, as described above, the characterization device can comprise a data processing unit making it possible to implement the VIM method from data recorded during one or more study phases.

Generally, and applicable to everything that has been stated above, the light source is preferably not cooled by an external temperature regulation system as described in the documents JP2011009358 and CN101290340. In effect, the proposed method and the associated device are such that cooling is not necessary preferably at least during the initialisation phase.

1. Method for characterizing a photovoltaic element comprising:
studying a behavior of the photovoltaic element in response to application of a light beam from a light source, at a study emitting power, said studying comprising measuring at least one electrical parameter representative of an operation of the photovoltaic element, and
initializing before the, studying, said initializing comprising adjusting an operating temperature of the light source as a function of the study emitting power.

2. The method according to claim 1, the adjusting comprises passing an electrical current through the light source, wherein the electrical current is a function of the study emitting power, said studying being triggered when said operating temperature is stabilized.

3. The method according to claim 1, wherein the adjusting comprises passing an electrical current through the light source for an initialization time, wherein the electrical current is of an intensity that is a function of an initialization emitting power different from the study emitting power.

4. The method according to claim 3, wherein the initialization time is a function of a value representative of a current temperature of the light source prior to triggering the initializing, and of a value representative of a desired temperature of the light source associated with the study emitting power of the studying.

5. The method according to claim 4, wherein the current temperature T0 is lower than the desired temperature T1, and the initialization time t is calculated according to the formula (Tmax−T0)*(1−e^{-t}^{_{/Rth.Cth}})=T1−T0 with Tmax being the temperature associated with the initialization emitting power, Rth the thermal resistance of the thermal model of the light source, Cth the heat capacity of the thermal model of the light source.

6. The method according to claim 4, wherein the current temperature T0 is higher than the desired temperature T1, and the initialisation initialization time t is calculated according to the formula T0.e^{-t}^{_{/Rth.Cth}}=T1 with Rth being the thermal resistance of the thermal model of the light source, Cth the heat capacity of the thermal model of the light source, and wherein, during the adjusting, the initialization emitting power of the light source is zero.

7. The method according to claim 1, comprising at least two successive phases of studying associated with different study emitting powers, each studying phase being preceded by an associated initializing phase.

8. The method according to claim 1, wherein studying comprises homogenizing the lighting received by at least a part of the photovoltaic element.

9. The method according to claim 8, wherein the homogenizing the lighting is implemented by means of at least one of a reflection element and a control of the operation of light-emitting diodes of the light source.

10. The method according to claim 1, wherein the electrical parameter measured during the measuring is at least one of a voltage and a current from the photovoltaic element.

11. Device for characterizing a photovoltaic element, said device comprising:
a light source,
an element for studying the behavior of the photovoltaic element in response to application of a light beam from the light source and exhibiting a study emitting power, said study element being provided with at least one system for measuring an electrical parameter from the photovoltaic element, and
an initialization component configured to adjust an operating temperature of the light source as a function of the study emitting power,
a computation unit interfaced with the initialization component and the study element, said computation unit being configured to perform the method according to claim 1.

12. The device according to claim 11, which comprises a reflection element comprising a duct provided with two ends, the light source being arranged at a first end of the duct so that the light beam is directed in the duct towards a second end of the duct comprising a bearing surface suitable for being placed in contact on an active face of the photovoltaic element, an internal surface of the duct being at least partially formed by a mirror.

13. The device according to claim 12, wherein an interior of the duct is delimited by a cylinder.

14. The device according to claim 11, wherein the light source comprises a matrix of light-emitting diodes.

15. The device according to claim 12, wherein the light source comprises a matrix of light-emitting diodes, the light-emitting diodes of the matrix of diodes being arranged in the form of a square or a rectangle, a distance separating the two ends of the duct is substantially equal to a distance from a greater side of the matrix of diodes.

16. The device according to claim 14, wherein the matrix of diodes is divided into a plurality of groups each comprising at least one diode, the emitting powers of the groups being controlled independently from one group to another.

17-18. (canceled)

19. The device according to claim 13, wherein the cylinder has a square or rectangular section.

20. The device according to claim 13, wherein the light source comprises a matrix of light-emitting diodes, the light-emitting diodes of the matrix of diodes being arranged in the form of a square or a rectangle, a distance separating the two ends of the duct is substantially equal to a distance from a greater side of the matrix of diodes.

21. The device according to claim 15, wherein the matrix of diodes is divided into a plurality of groups each comprising at least one diode, the emitting powers of the groups being controlled independently from one group to another.

22. The device according to claim 20, wherein the matrix of diodes is divided into a plurality of groups each comprising at least one diode, the emitting powers of the groups being controlled independently from one group to another.
